(19) United States
(12) Patent Application Publication
(10) Pub. No.: US 2014/0332634 A1
(43) Pub. Date: Nov. 13, 2014

(54) MULTI-PURPOSE PERSONAL PROPULSION SYSTEM

(71) Applicant: JLIP, LLC, Dania Beach, FL (US)

(72) Inventors: Raymond LI, St. Johns (CA); Donald Hubbard, JR., Hollywood, FL (US); Michael A. Sparks, Pompano Beach, FL (US)

(73) Assignee: JLIP, LLC, Dania Beach, FL (US)

(21) Appl. No.: 14/276,148

(22) Filed: May 13, 2014

Related U.S. Application Data
(60) Provisional application No. 61/822,885, filed on May 13, 2013.

(51) Int. Cl. B64C 39/02; F41H 5/02

(52) U.S. Cl. CPC B64C 39/026; F41H 5/02
USPC 244/23 A; 89/36.01

(57) ABSTRACT

A personal propulsion system, including an assembly adapted to support a passenger and achieve flight through the discharge of pressurized fluid; and a pressurized fluid source in fluid communication with the assembly, where the pressurized fluid source does not achieve flight, and where the pressurized fluid source is constructed at least in part from one or more ballistic armor materials.

### CROSS-REFERENCE TO RELATED APPLICATION

This application is related to and claims priority to U.S. Provisional Patent Application Ser. No. 61/822,885, filed May 13, 2013, entitled Multi-Purpose Personal Propulsion System, the entirety of which is incorporated herein by reference.

### STATEMENT REGARDING FEDERALLY SPONSORED RESEARCH OR DEVELOPMENT

n/a

### FIELD OF THE INVENTION

The present invention relates to personal propulsion devices and methods of use thereof.

### SUMMARY OF THE INVENTION

The present disclosure advantageously provides a personal propulsion system, including, an assembly adapted to support a passenger and achieve flight through the discharge of pressurized fluid; and a pressurized fluid source in fluid communication with the assembly, wherein the pressurized fluid source does not achieve flight, and where the pressurized fluid source is constructed at least in part from one or more ballistic armor materials. The pressurized fluid source may include a marine hull and/or a sealed, substantially water-tight, unmanned marine hull. The system may include a hose connecting the assembly to the pressurized fluid source, where the hose is constructed at least in part from one or more ballistic armor materials. The passenger support assembly may be constructed at least in part from one or more ballistic armor materials. The ballistic armor material may include at least one of a ceramic, polymer, composite, or other energy-dispersing component.

A personal propulsion system is also disclosed, including an assembly adapted to support a passenger and achieve flight through the discharge of pressurized fluid; a pressurized fluid source in fluid communication with the assembly, where the pressurized fluid source does not achieve flight; an air supply coupled to the pressurized fluid source; and a regulator coupled to the assembly and in fluid communication with the air supply, where the regulator is adapted to provide air to a passenger in the assembly. The pressurized fluid source may include a marine hull, and the air supply may be disposed within the hull or attached to an external surface of the hull. The system may include a first hose connecting the assembly to the pressurized fluid source, and a second hose connecting the air supply to the regulator. The second hose may be disposed within the first hose, and the first and second hoses may be substantially coaxial.

Another personal propulsion system is disclosed, including an assembly adapted to support a passenger and achieve flight through the discharge of pressurized fluid; a pressurized fluid source in fluid communication with the assembly, where the pressurized fluid source does not achieve flight; and a potable water supply coupled to the pressurized fluid source, where the potable water supply is accessible to a passenger in the assembly. The pressurized fluid source may include a marine hull, and the potable water supply may be disposed within the hull or attached to an external surface of the hull. A first hose may connect the assembly to the pressurized fluid source, and a second hose may connect the potable water supply to the assembly. The second hose may be disposed within the first hose, and the first and second hoses may be substantially coaxial.

Still another personal propulsion system is provided, including an assembly adapted to support a passenger and achieve flight through the discharge of pressurized fluid; a pressurized fluid source in fluid communication with the assembly, wherein the pressurized fluid source does not achieve flight; and a platform coupled to the pressurized fluid source, the platform adapted to support a person. The platform may include a stretcher and/or may be buoyant. The pressurized fluid source may include a marine hull, and the platform may be retractable within the marine hull.

A personal propulsion system is provided, including an assembly adapted to support a passenger and achieve flight through the discharge of pressurized fluid; a pressurized fluid source in fluid communication with the assembly, wherein the pressurized fluid source does not achieve flight; and a light source coupled to the pressurized fluid source, wherein the light source is controllable from the passenger support assembly. The pressurized fluid source may include a marine hull, and the light source is coupled to an underside of the marine hull and adapted to illuminate an area under the pressurized fluid source. The passenger support assembly may include one or more input controls to selectively adjust at least one of an intensity, output, and color of the light source. The system may include at least one of a GPS, radar, and communications system coupled to the pressurized fluid source and selectively controllable from the passenger support assembly.

A personal propulsion system is disclosed, including an assembly adapted to support a passenger and achieve flight through the discharge of pressurized fluid; a pressurized fluid source in fluid communication with the assembly, wherein the pressurized fluid source includes a marine hull that does not achieve flight; and at least one anchor element coupled to an underside of the marine hull. The at least one anchor element may be configured as a hand-hold point, and may include at least one of a retractable cleat, a hand rail, and/or a handle.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of an example of an embodiment of a personal propulsion system constructed in accordance with the principles of the present disclosure; and

FIG. 2 is an illustration of an example of an embodiment of a pressurized fluid source of the system shown in FIG. 1.

### DETAILED DESCRIPTION OF THE INVENTION

The present disclosure provides examples of multi-purpose personal propulsion systems and methods of use thereof. The systems may generally include a fluid conduit or hose that delivers pressurized fluid to the passenger assembly, and a pressurized fluid source attached to the conduit. Other personal propulsion devices and features thereof are disclosed in U.S. Pat. Nos. 7,258,301 and 8,336,805, as well as U.S. Patent Application Ser. No.61/801,165, entitled Personal Propulsion Devices With Improved Balance, U.S. Patent Application Ser. No. 61/805,257, entitled Waterproof Rotary Contact Assembly, and U.S. Patent Application Ser. No. 61/822,612, entitled Tandem Personal Propulsion Device, the entirety of all of which are hereby incorporated by reference.

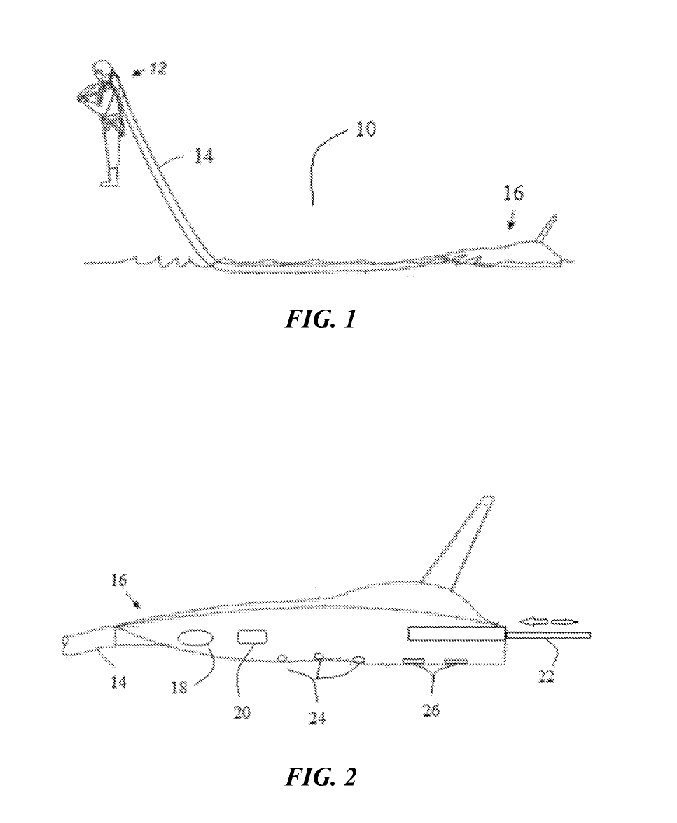

Now referring to FIG. 1, a personal propulsion system 10 is shown with the passenger assembly 12, the fluid conduit or hose 14, and the pressurized fluid source 16. The pressurized fluid source or unit may include an unmanned marine unit having a substantially water-tight hull (operable on a water surface and/or submersible), a boat, a personal watercraft such as a wave runner or jet ski, or a pump located on land or in/on water.

The passenger assembly may include one or more components that provide or generate a force to aid in elevating, moving, stabilizing, and/or otherwise controllably using the system. For example, the passenger assembly may include one or more nozzles or outlets that discharged a fluid to move, stabilize, elevate, or otherwise affect the position of the passenger assembly. In the examples shown in FIG. 1, the passenger assembly includes a plurality of downward-facing nozzles that discharge pressurized fluid received from the pressurized fluid source to move, stabilize, elevate or otherwise direct or orient the passenger assembly as desired.

The passenger assembly, fluid conduit, and/or the pressurized fluid source may be constructed at least in part form or otherwise include a ballistic armor material to protect the respective portions or components of the system from projectile damage (e.g., bullets, missiles, or the like). Such armor materials may include, for example, protective ceramics, polymers, composites, or other energy dispersing construct, material, or mechanism. The fluid conduit may include, for example, a Kevlar layer embedded or otherwise disposed within its length. Should the pressurized fluid source include a marine hull, the hull may include a layer or overlay of protective material to shield the internal components of the hull from external projectile damage.

In addition and/or alternatively to the protective materials, the pressurized fluid source may include one or more noise dampening materials to reduce the sound from the inner workings or components of the fluid source.

The system may include an air supply or reservoir 18 coupled to the pressurized fluid source and in fluid communication with or otherwise accessible to a person supported by the passenger assembly. For example, a large, compressed air tank or reservoir may be coupled on an exterior surface or internal to the pressurized fluid source. An air hose or conduit may connect to the reservoir and extend to the passenger assembly, where a regulator, valve, or other controllable mechanism may allow a user to selectively breathe air provided by the air source 18. The air hose may be coupled to in, on, or exterior to the hose 14. Locating the air source on or in the pressurized fluid source rather than the passenger assembly can aid in retaining or increasing the maneuverability and flight capabilities of the passenger assembly, while also providing an air source for the passenger or operator of the system to conduct underwater operations or activities for prolonged period of time.

The system may include a potable water supply or reservoir 20 coupled to the pressurized fluid source and in fluid communication with or otherwise accessible to a person supported by the passenger assembly. For example, a large, water tank or reservoir may be coupled on an exterior surface or internal to the pressurized fluid source. A hose or conduit (secondary or auxiliary to the hose 14) may connect to the reservoir and extend to the passenger assembly, where a regulator, valve, or other controllable mechanism may allow a user to selectively drink or otherwise use the potable water supply 20. The secondary water hose may be coupled to in, on, or exterior to the hose 14. Locating the potable water supply on or in the pressurized fluid source rather than the passenger assembly can aid in retaining or increasing the maneuverability and flight capabilities of the passenger assembly.

The system may include a platform 22 coupled to the pressurized fluid source 16 to carry gear, supplies, and/or one or more passengers. The platform may, for example, include a stretcher or buoyant platform that can carry an injured person. The platform may be selectively deployable and retractable into a housing, body, or hull of the pressurized fluid source.

The system may include one or more light source(s) 24 coupled to the pressurized fluid source and selectively operable by a person supported by the passenger assembly. For example, the system may include a plurality of LEDs on an underside of the pressurized fluid source operable to illuminate an area (such as the water below) the pressurized fluid source. The light sources may be operable or controllable through one or more input controls on the passenger assembly, where the communication between the passenger assembly and the light sources can be wired or wireless. The one or more input controls on the passenger assembly may provide for the selective operation or adjustment of a light intensity, output, and/or color of any of the light sources. The light sources may have sufficient output to illuminate a large area of water under and around the pressurized water source to aid in search and rescue activities, undersea fishing or crabbing, or other underwater activities that illumination may aid.

The system may include additional components or modules coupled to or disposed within the pressurized fluid source that are operable from the passenger assembly to provide added functionality of the system while maintaining the reduced weight of the passenger assembly. For example, the system may include a GPS module or tracking component, radar or other surveillance components, and/or communications components disposed on or within the pressurized fluid source, and operable from the passenger assembly either through a wired or wireless link.

The system may include one or more anchor points or elements 26 coupled to the pressurized fluid source that enable the grasping, coupling, or connecting of users in the passenger assembly, and/or gear or equipment. For example, a user or passenger coupled to the passenger assembly may be submerged underneath the fluid source and grab onto or otherwise couple to the anchor points, which may be in the form of a retractable cleat. The user may use the powered output of the passenger assembly to move the pressurized fluid source while remaining submerged and coupled to the fluid source, and/or a user may remain submerged and out of sight while coupled to the pressurized fluid source. The anchor points may be located on an underside of the pressurized fluid source, e.g., where the pressurized fluid source includes a marine hull, located under the water line of the hull. The anchor points may be selectively deployable and retractable into and out of the marine hull.

The system may include one or more mounting points on the passenger assembly and/or the pressurized fluid source for additional gear, equipment, weapons, or the like.

It will be appreciated by persons skilled in the art that the present invention is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein (or incorporated by reference) may illustrate features not expressly indicated on other figures or embodiments, it is understood that the features and components of the examples disclosed herein are not necessarily exclusive of each other and may be included in a variety of different combinations or configurations without departing from the scope and spirit of the invention. A variety of modifications and variations are possible in light of the above teachings without departing from the scope and spirit of the invention, which is limited only by the following claims.

What is claimed is:

1. A personal propulsion system, comprising:
an assembly adapted to support a passenger and achieve flight through the discharge of pressurized fluid; and
a pressurized fluid source in fluid communication with the assembly, wherein the pressurized fluid source does not achieve flight, and wherein the pressurized fluid source is constructed at least in part from one or more ballistic armor materials.

2. The system of claim 1, wherein the pressurized fluid source include a marine hull.

3. The system of claim 2, wherein the pressurized fluid source includes a sealed, substantially water-tight, unmanned marine hull.

4. The system of claim 1, further comprising a hose connecting the assembly to the pressurized fluid source, wherein the hose is constructed at least in part from one or more ballistic armor materials.

5. The system of claim 1, wherein the assembly is constructed at least in part from one or more ballistic armor materials.

6. The system of claim 1, wherein the ballistic armor material includes one of a ceramic, polymer, composite, or other energy-dispersing component.

7. A personal propulsion system, comprising:
an assembly adapted to support a passenger and achieve flight through the discharge of pressurized fluid;
a pressurized fluid source in fluid communication with the assembly, wherein the pressurized fluid source does not achieve flight;
an air supply coupled to the pressurized fluid source; and
a regulator coupled to the assembly and in fluid communication with the air supply, wherein the regulator is adapted to provide air to a passenger in the assembly.

8. The system of claim 7, wherein the pressurized fluid source includes a marine hull, and wherein the air supply is disposed within the hull.

9. The system of claim 7, further comprising a first hose connecting the assembly to the pressurized fluid source, and a second hose connecting the air supply to the regulator.

10. The system of claim 7, further comprising a potable water supply coupled to the pressurized fluid source, wherein the potable water supply is accessible to a passenger in the assembly.

11. The system of claim 7, further comprising a platform coupled to the pressurized fluid source, wherein the platform is adapted to support a person.

12. The system of claim 11, wherein the platform is a stretcher.

13. The system of claim 11, wherein the platform is buoyant.

14. The system of claim 11, wherein the pressurized fluid source include a marine hull, and wherein the platform is retractable within the marine hull.

15. The system of claim 7, further comprising a light source coupled to the pressurized fluid source, wherein the light source is controllable from the assembly.

16. The system of claim 15, wherein the pressurized fluid source includes a marine hull, and wherein the light source is coupled to an underside of the marine hull and adapted to illuminate an area under the pressurized fluid source.

17. The system of claim 15, wherein the assembly includes one or more input controls to selectively adjust at least one of an intensity, output, and color of the light source.

18. The system of claim 7, further comprising at least one of a GPS, radar, and communications system coupled to the pressurized fluid source and selectively controllable from the assembly.

19. A personal propulsion system, comprising:
an assembly adapted to support a passenger and achieve flight through the discharge of pressurized fluid;
a pressurized fluid source in fluid communication with the assembly, wherein the pressurized fluid source includes a marine hull that does not achieve flight; and
at least one anchor element coupled to an underside of the marine hull.

20. The system of claim 19, wherein the at least one anchor element includes at least one of a hand-hold point, a retractable cleat, a hand rail, and a handle.
